(19) United States
(12) Patent Application Publication
(10) Pub. No.: US 2013/0106991 A1
(43) Pub. Date: May 2, 2013

(54) INFORMATION PROCESSING APPARATUS, INFORMATION PROCESSING METHOD, AND PROGRAM

(71) Applicant: Sony Corporation, Tokyo (JP)

(72) Inventors: Tomonori Misawa, Tokyo (JP); Hideo Nagasaka, Kanagawa (JP)

(73) Assignee: SONY CORPORATION, Tokyo (JP)

(21) Appl. No.: 13/659,238

(22) Filed: Oct. 24, 2012

(30) Foreign Application Priority Data
Oct. 31, 2011 (JP) 2011-238477

(51) Int. Cl. H04N 5/232

(52) U.S. Cl. CPC H04N 5/23238
USPC 348/36

(57) ABSTRACT

Provided is an information processing apparatus including a first acquisition part acquiring a subject image and first capturing position information indicating an image capturing position of the image; a second acquisition part acquiring a wide range image captured with a visual field in a wider range than that for a visual field in capturing an image of the subject and second capturing position information indicating an image capturing position of the wide range image; and a display controller forming and displaying an image of a virtual space having an orientation axis corresponding to the image capturing position in a circumferential direction of a circle with its center at a reference point in the virtual space. The display controller draws the wide range image based on the second capturing position information, when drawing the subject image at a drawing position based on the first capturing position information in the virtual space.

### CROSS-REFERENCE TO RELATED APPLICATION

The present application claims priority from Japanese Patent Application No. JP 2011-238477 filed in the Japanese Patent Office on Oct. 31, 2011, the entire content of which is incorporated herein by reference.

### BACKGROUND

The present disclosure relates to an information processing apparatus, an information processing method, and a program.

Image capturing apparatuses are multi-functionalized in recent years and, for example, there is a technology for arranging and displaying a number of photographic images captured by the image capturing apparatus as thumbnail images. In such a technology, the plural thumbnail images are displayed into a matrix shape, for example, whereas there is also a technology described in Japanese Patent Application Publication No. 2007-78842 (hereinafter referred to as Patent Literature 1) as follows.

Patent Literature 1 describes a technology in which the position of a image capturing site of an image capturing person is set within a display region based on image capturing information concerning image capturing positions, image capturing distances and image capturing orientations, and arrangement positions of the photographic images are set such that positions and orientations of the subject relative to the image capturing site can be distinguishable.

### SUMMARY

Moreover, from a viewpoint for improvement of convenience for browsing photographic images and the like, a technology is proposed in which photographic images are arranged and displayed in a virtual space based on image capturing information. According to this technology, the user browses the photographic images arranged in the virtual space and can grasp image capturing positions, image capturing orientations and the like of the subject easily.

Incidentally, in many cases, the photographic images are mainly captured focusing on the subject, and situations around the subject are not included in the capturing. For this reason, upon displaying the photographic images obtained by capturing images of the subject in the virtual space, the image capturing positions and the like of the subject can be grasped, whereas it is hard to be grasped under what kind of environment the images of the subject have been captured.

It is desirable to propose a method capable of readily grasping environment or the like where images of the subject have been captured in arranging and displaying the subject images in a virtual space.

According to an embodiment of the present disclosure, there is provided an information processing apparatus, including a first acquisition part acquiring a subject image obtained by capturing an image of a subject and first capturing position information indicating an image capturing position of the subject image, a second acquisition part acquiring a wide range image captured with a visual field in a wider range than that for a visual field in capturing an image of the subject and second capturing position information indicating an image capturing position of the wide range image, and a display controller forming and displaying an image of a virtual space having an orientation axis corresponding to the image capturing position in a circumferential direction of a circle with its center at a reference point in the virtual space. The display controller draws the wide range image as well based on the second capturing position information, when drawing the subject image at a drawing position based on the first capturing position information in the virtual space.

According to an embodiment of the present disclosure, there is provided an information processing method, including acquiring a subject image obtained by capturing an image of a subject and first capturing position information indicating an image capturing position of the subject image, acquiring a wide range image captured with a visual field in a wider range than that for a visual field in capturing an image of the subject and second capturing position information indicating an image capturing position of the wide range image, forming and displaying an image of a virtual space having an orientation axis corresponding to the image capturing position in a circumferential direction of a circle with its center at a reference point in the virtual space, and drawing the wide range image as well based on the second capturing position information when drawing the subject image at a drawing position based on the first capturing position information in the virtual space.

According to an embodiment of the present disclosure, there is provided a program causing a computer to acquire a subject image obtained by capturing an image of a subject and first capturing position information indicating an image capturing position of the subject image, acquire a wide range image captured with a visual field in a wider range than that for a visual field in capturing an image of the subject and second capturing position information indicating an image capturing position of the wide range image, form and display an image of a virtual space having an orientation axis corresponding to the image capturing position in a circumferential direction of a circle with its center at a reference point in the virtual space, and draw the wide range image as well based on the second capturing position information when drawing the subject image at a drawing position based on the first capturing position information in the virtual space.

And according to the present disclosure, a display controller draws a wide range image as well when drawing a subject image in a virtual space. Herein, the wide range image is an image which includes an image capturing position of the subject and is captured with a visual field in a wider range than that for a visual field in capturing an image of the subject. Therefore, the user can grasp the environment or the like where the image of the subject have been captured easily due to the wide range image drawn along with the subject image.

As described above, according to the present disclosure, the environment or the like where the images of the subject have been captured can also be grasped easily in arranging and displaying the subject images in the virtual space.

### BRIEF DESCRIPTION OF THE DRAWINGS

FIG. 1 is a diagram illustrating an outline configuration of an image display system according to one embodiment;

FIG. 2 is a block diagram illustrating a configuration of the image display system according to one embodiment;

FIG. 3 is a block diagram illustrating a modification of the configuration of the image display system according to one embodiment;

FIG. 4 is a block diagram illustrating a detailed configuration of an image capturing apparatus according to one embodiment;

FIG. 5 is a block diagram illustrating a detailed configuration of a display apparatus according to one embodiment;

FIG. 6 is a block diagram illustrating a functional configuration of a display control apparatus;

FIGS. 7A to 7C are diagrams illustrating relation between rotation angles of a rotational camera platform and subject images captured by the image capturing apparatus;

FIG. 8 is a diagram conceptually illustrating a virtual three-dimensional space in which the subject images captured with the rotation angles illustrated in FIGS. 7A to 7C are arranged;

FIG. 9 is a top view of the virtual three-dimensional space illustrated in FIG. 8;

FIGS. 10A to 10C are diagrams illustrating relation between an orientation of an electronic compass and the rotation angle of the rotational camera platform;

FIG. 11 is a diagram illustrating a display example of the virtual three-dimensional space in which the subject images are arranged by a display or a large screen display apparatus;

FIG. 12 is a diagram for explaining drawing positions of the subject images and panoramic image in the virtual three-dimensional space;

FIG. 13 is a diagram illustrating a display example of the subject images and panoramic image by the display or the large screen display apparatus;

FIG. 14 is a schematic diagram for explaining a flow in which the subject image acquired from a first acquisition part is drawn in the virtual three-dimensional space;

FIG. 15 is a diagram illustrating a display example of the subject image by the display or the large screen display apparatus;

FIG. 16 is a diagram for explaining movement of a viewpoint in the virtual three-dimensional space;

FIG. 17 is a flowchart illustrating display processing of the subject images and panoramic image in the virtual three-dimensional space;

FIG. 18 is a diagram for explaining an orientation angle and the like of the viewpoint in the virtual three-dimensional space;

FIGS. 19A and 19B are diagrams illustrating relation between the panoramic image and a display screen of the display apparatus;

FIG. 20 is a diagram illustrating relation between the panoramic image and the display screen of the display apparatus; and

FIG. 21 is a flowchart illustrating drawing processing of the subject images captured automatically in the virtual three-dimensional space.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Herein, descriptions will be made in the following order:

1. Configuration of Image Display System

2. Configuration of Image Capturing Apparatus

3. Configuration of Display Apparatus

4. Configuration of Display Control Apparatus
4-1. Arrangement of Subject Images in Virtual Three-Dimensional Space
4-2. Display of Subject Images and Panoramic Image in Virtual Three-Dimensional Space
4-3. Outline of Drawing of Subject Images in Virtual Three-Dimensional Space
4-4. Switching Display of Panoramic Images in Response to Viewpoint Movement

5. Operation of Image Display System

6. Conclusion

### 1. Configuration of Image Display System

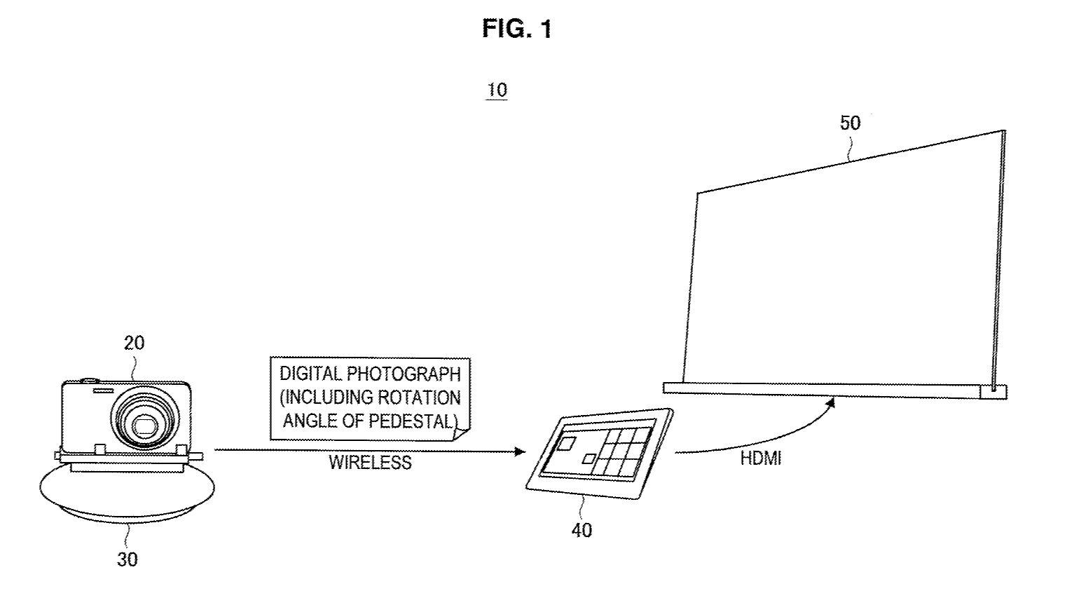

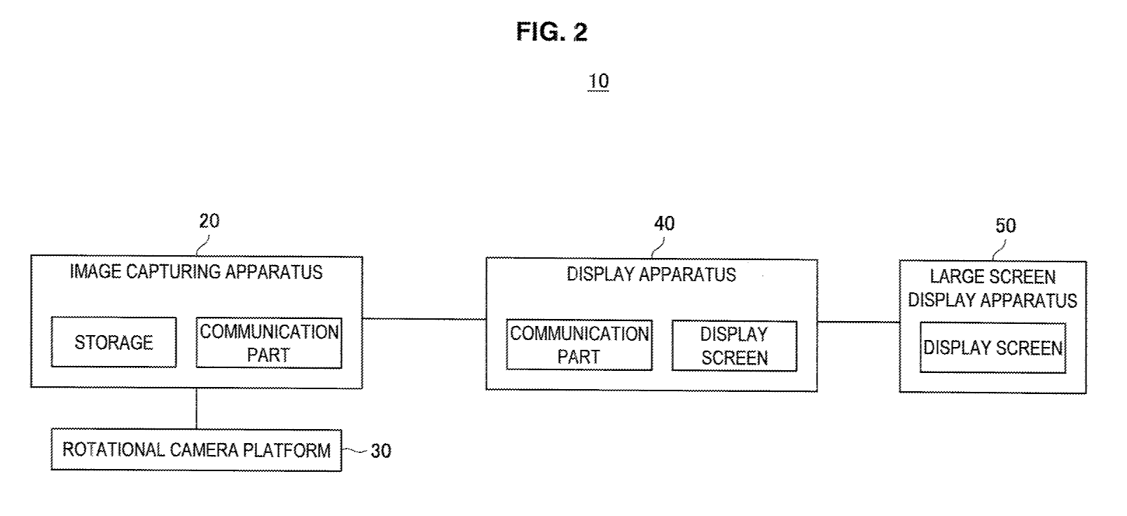

A configuration of an image display system 10 according to one embodiment of the present disclosure is described referring to FIG. 1 and FIG. 2. FIG. 1 is a diagram illustrating an outline configuration of the image display system 10 according to one embodiment. FIG. 2 is a block diagram illustrating a configuration of the image display system 10 according to one embodiment.

The image display system 10 arranges captured subject images in a virtual three-dimensional space as one example of virtual spaces, and displays, as a two-dimensional image, the virtual three-dimensional space in which the subject images are arranged. As illustrated in FIG. 1 and FIG. 2, the image display system 10 includes an image capturing apparatus 20, a rotational camera platform 30, a display apparatus 40 and a large screen display apparatus 50.

The image capturing apparatus 20 is a digital still camera, for example, and captures images of the subject. The image capturing apparatus 20 can also capture a panoramic image as one example of wide range images. The image capturing apparatus 20 can perform a function (party photographing function) in which, on the occasion of a gathering such, for example, as a party, the face of the subject is detected by automatically performing rotation (pan), angle adjustment (tilt) and zoom and its images are automatically captured. The image capturing apparatus 20 stores the captured images in a storage.

The rotational camera platform 30 is a camera platform rotatable by 360 degrees in the state where the image capturing apparatus 20 is situated thereon. The rotational camera platform 30 has an automatic tracking function of each motion of the pan, tilt and zoom and the face of the subject. By connecting the situated image capturing apparatus 20 to the rotational camera platform 30, the above-mentioned party photographing function is realized. In addition, in rotational camera platform 30, an operation part for the case of capturing the panoramic image may be provided.

The image capturing apparatus 20 can communicate with the display apparatus 40 via a wireless network or the like. Then, the image capturing apparatus 20 transmits the subject images captured automatically by the party photographing function (subject images stored in the storage) to the display apparatus 40. At this stage, the image capturing apparatus 20 also transmits information such as rotation angles of the rotational camera platform 30 in capturing the subject images as well as the subject images. In addition, the detailed configuration of the image capturing apparatus 20 is mentioned later.

The display apparatus 40 displays various images on a display screen, arranges the subject images received from the image capturing apparatus 20 (subject images captured automatically by the party photographing function) in the virtual three-dimensional space, and displays, as a two-dimensional image, the virtual three-dimensional space in which the subject images are arranged. The display apparatus 40 displays the virtual three-dimensional space on the display screen of the display apparatus 40 or on the large screen display apparatus 50 connected to the display apparatus 40. In addition, the details of the virtual three-dimensional space are mentioned later.

The large screen display apparatus 50 is connected to the display apparatus 40, and data is exchanged therebetween. The large screen display apparatus 50 displays, on its display screen, the virtual three-dimensional space in which the automatically captured subject images are arranged by the image capturing apparatus 20.

In addition, the image capturing apparatus 20 is supposed to be a digital still camera in the above description, but is not limited to this. The image capturing apparatus 20 only has to have a function for capturing images of the subject, and may be a mobile phone, a smart phone, a PDA (Personal Digital Assistant), a portable AV player, an electronic book, an electronic dictionary or the like, for example.

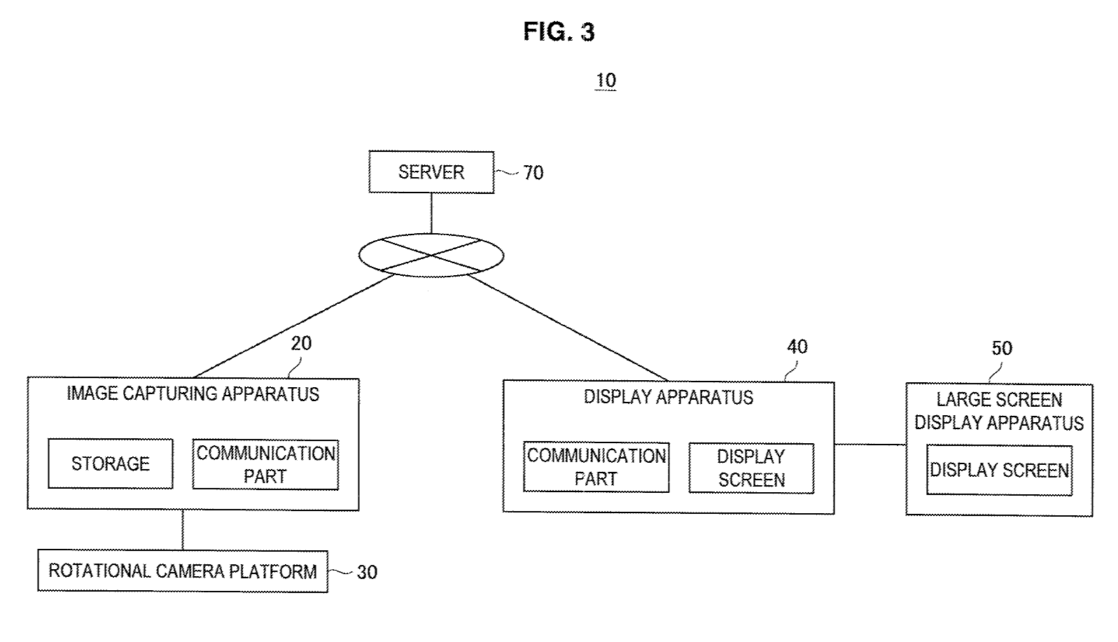

Moreover, the display apparatus 40 is supposed to receive the subject images arranged in the virtual three-dimensional space from the image capturing apparatus 20 in the above description, but is not limited to this. As illustrated in FIG. 3, for example, the display apparatus 40 may receive the subject images stored in a server, and arrange and display the subject images thus received in the virtual three-dimensional space.

FIG. 3 is a block diagram illustrating a modification of a configuration of the image display system 10 according to one embodiment. The image capturing apparatus 20 according to the modification in FIG. 3 transmits the subject images, which are captured automatically, to a server 70 via a wireless network or the like instead of the display apparatus 40. The server 70 stores the subject images received from the image capturing apparatus 20, and transmits the subject images to the display apparatus 40 in response to a request from the display apparatus 40.

### 2. Configuration of Image Capturing Apparatus

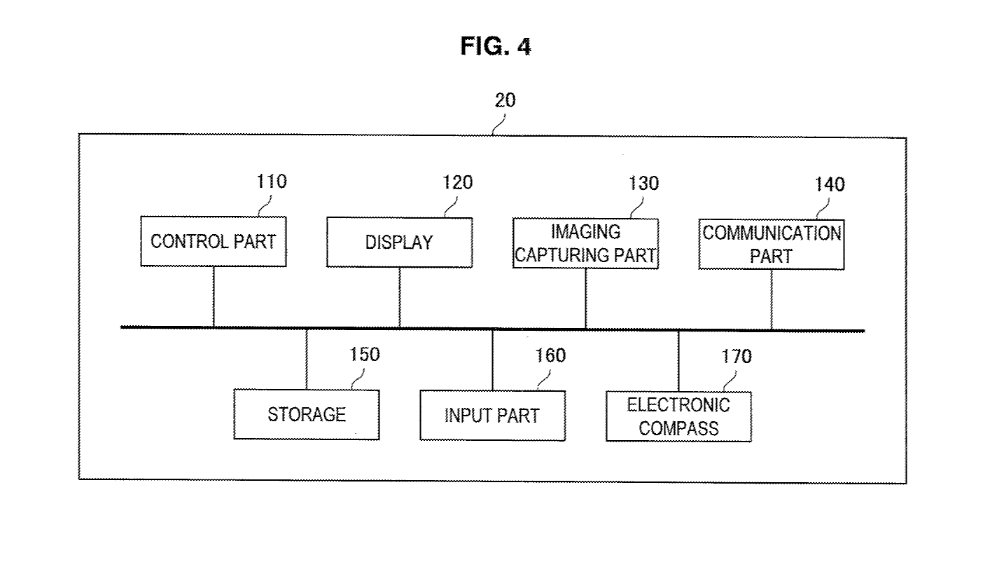

The detailed configuration of the image capturing apparatus 20 according to one embodiment of the present disclosure is described referring to FIG. 4. FIG. 4 is a block diagram illustrating the detailed configuration of the image capturing apparatus 20 according to one embodiment.

As illustrated in FIG. 4, the image capturing apparatus 20 includes a control part 110, a display 120, an imaging capturing part 130, a communication part 140, a storage 150, an input part 160 and an electronic compass 170.

The control part 110 exchanges signals between itself and each block of the image capturing apparatus 20 to perform various calculations, and controls the whole operation of the image capturing apparatus 20. The control part 110 includes a CPU, a ROM and a RAM, for example.

The display 120 is an LCD such as TFT (Thin Film Transistor) or an OELD (Organic Electro-Luminescence Display), for example, and displays various images on its display screen. The display 120 displays a preview image in capturing the image, for example.

The imaging capturing part 130 captures the subject images such as still images (photographs) and moving images with an image sensor such as CMOS (Complementary Metal Oxide Semiconductor) and CCD (Charge Coupled Devices) sensors, for example. The imaging capturing part 130 has a function to detect the face of the subject, and captures the image of the subject automatically when a smiling face is detected. Moreover, the imaging capturing part 130 can capture a panoramic image. In addition, the imaging capturing part 130 captures a plurality of subject images automatically during execution of the party photographing function.

The imaging capturing part 130 can acquire not only the subject images but information on image capturing times and image capturing positions. The image capturing time is acquired from a clock (not shown) built in the image capturing apparatus 20. The time of the built-in clock may be corrected based on the time information received by a GPS sensor (not shown), for example, from GPS satellites. In addition, the time is not as a time of the day but includes the concept of the time of the year.

The communication part 140 has a network interface card, a modem, or the like, for example, and performs communication processing between itself and other equipment via a network such as the Internet and a LAN (Local Area Network). The communication part 140 may include a wireless LAN module or a WWAN (Wireless Wide Area Network) module. The communication part 140 transmits the captured subject images and panoramic image to other equipment such as the display apparatus 40.

The storage 150 is a flash memory, for example, and stores the subject images captured by the imaging capturing part 130. Moreover, the storage 150 stores a control program which the control part 110 executes.

The input part 160 accepts an operation of a user and outputs an input signal to the control part 110. The input part 160 includes a power switch, a shutter release and the like, for example. The input part 160 may include a touch panel integrally provided with the display 120.

The electronic compass 170 includes a magnetic sensor detecting the earth magnetism which the earth emits, and calculates a direction (orientation) toward which the image capturing apparatus 20 faces based on the detected earth magnetism. The electronic compass 170 outputs the calculated orientation of the image capturing apparatus 20 to the control part 110.

### 3. Configuration of Display Apparatus

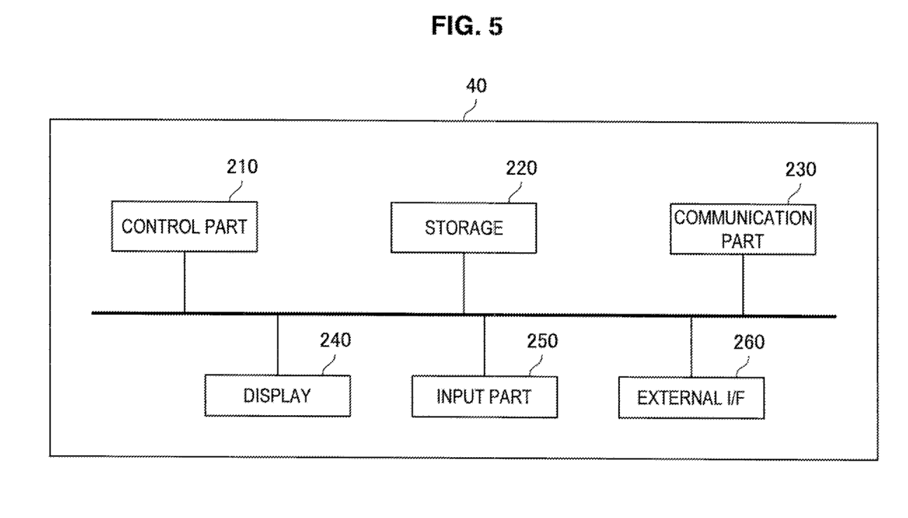

The detailed configuration of the display apparatus 40 according to one embodiment of the present disclosure is described referring to FIG. 5. FIG. 5 is a block diagram illustrating the detailed configuration of the display apparatus 40 according to one embodiment.

As illustrated in FIG. 5, the display apparatus 40 includes a control part 210, a storage 220, a communication part 230, a display 240, an input part 250 and an external I/F (interface) 260.

The control part 210 exchanges signals between itself and each block of the display apparatus 40 to perform various calculations, and controls the whole operation of the display apparatus 40. The control part 210 performs processing such as arrangement of the subject images in the virtual three-dimensional space, the processing mentioned below. The control part 210 includes a CPU, a ROM and a RAM, for example.

The storage 220 is a flash memory and/or HDD (Hard Disk Drive), for example, and stores the subject images received from the image capturing apparatus 20. Moreover, the storage 220 stores the control program which the control part 210 executes.

The communication part 230 includes a network interface card, a modem, or the like, for example, and performs communications processing between itself and other equipment (the image capturing apparatus 20 and/or the server 70) via a network such as the Internet and a LAN (Local Area Network). The communication part 230 receives the subject images captured automatically by the image capturing apparatus from the image capturing apparatus 20 or the server 70 (also referred to as the image capturing apparatus 20 and the like).

The display 240 is an LCD such as TFT (Thin Film Transistor) or an OELD (Organic Electro-Luminescence Display), for example. The display 240 arranges the subject images which the communication part 230 has received from the image capturing apparatus 20 in the virtual three-dimensional space, and displays, as a two-dimensional image, the virtual three-dimensional space in which the subject images are arranged on its display screen.

The input part 250 is a touch panel integrally provided with the display 240, for example. In the state where an image or GUI (Graphical User Interface) is displayed by executing an image display application, for example, the input part 250 detects a touch operation of the user to output to the control part 210. Moreover, the touch panel is used for the user selecting an image to perform entire screen display or moving a viewpoint (zoom-in or zoom-out) during the execution of the image display application.

The external I/F 260 connects with external equipment (for example, the large screen display apparatus 50) in conformity with various standards such as HDMI (High-Definition Multimedia Interface) and USB (Universal Serial Bus), for example, and exchanges data therebetween. For example, the display apparatus 40 transmits the subject images and panoramic image which are displayed on the display screen of the large screen display apparatus 50 via the external I/F 260.

### 4. Configuration of Display Control Apparatus

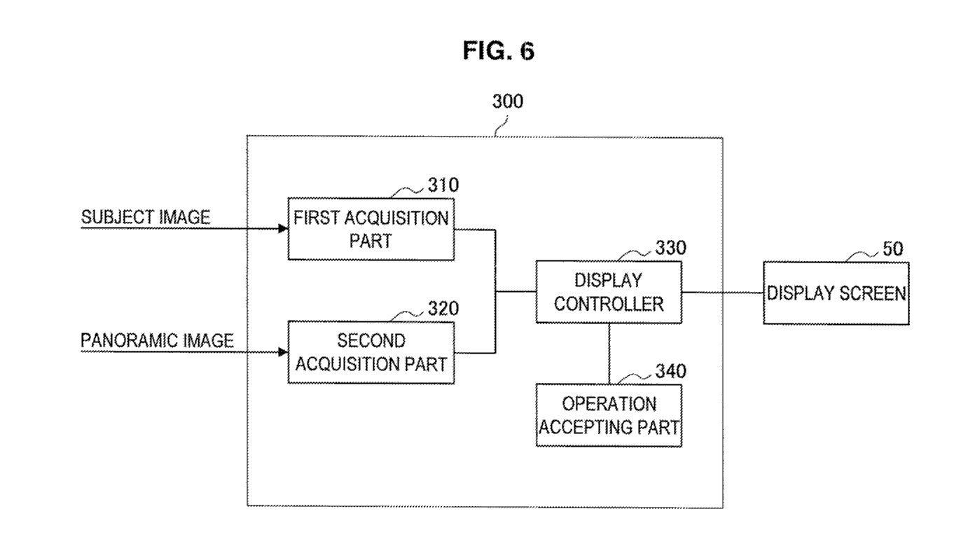

Referring to FIG. 6, a functional configuration of a display control apparatus 300 which is one example of an information processing apparatus which controls image display in the image display system 10 is described. FIG. 6 is a block diagram illustrating the functional configuration of the display control apparatus 300.

The display control apparatus 300 controls display of the subject images and panoramic image captured by the image capturing apparatus 20 on the display 120 of the display apparatus 40 or on the display screen of the large screen display apparatus 50. As illustrated in FIG. 6, the display control apparatus 300 includes a first acquisition part 310, a second acquisition part 320, a display controller 330 and an operation accepting part 340. In addition, the first acquisition part 310, second acquisition part 320, display controller 330 and operation accepting part 340 are realized due to functions of the control part 210 of the display apparatus 40, for example.

The first acquisition part 310 acquires a subject image obtained by capturing an image of the subject. For example, the first acquisition part 310 acquires the subject image from the image capturing apparatus 20 or the server 70. The subject image is captured by the image capturing apparatus which is situated on the rotational camera platform 30 which can rotate freely and rotates interlockingly with the rotation of the rotational camera platform 30. In addition, when plural subject images have been captured automatically by the image capturing apparatus 20, the plural subject images are acquired sequentially.

The first acquisition part 310 acquires first capturing position information which indicates image capturing positions of the subject images, when acquiring the subject images. Moreover, the first acquisition part 310 can also acquire first capturing time information which indicates image capturing times of the subject images, when acquiring the subject image. The first acquisition part 310 acquires the first capturing time information and the first capturing position information in association with the subject images. The first acquisition part 310 outputs the subject images, first capturing time information and first capturing position information thus acquired to the display controller 330.

The second acquisition part 320 acquires a panoramic image which includes an image capturing position of the subject and is one example of wide range images captured with a visual field in a wider range than that for a visual field in capturing the subject. The panoramic image is also captured by the image capturing apparatus 20 which rotates interlockingly with the rotation of the rotational camera platform 30. When plural panoramic images (for example, plural panoramic images different from one another in image capturing time) are captured automatically by the image capturing apparatus 20, the second acquisition part 320 acquires the plural panoramic images.

When acquiring the panoramic image, the second acquisition part 320 also acquires second capturing time information which indicates an image capturing time of the panoramic image and second capturing position information which indicates an image capturing position of the panoramic image. The second acquisition part 320 outputs the panoramic image, second capturing time information and second capturing position information thus acquired to the display controller 330.

The display controller 330 controls display of the subject images inputted from the first acquisition part 310 and the panoramic image inputted from the second acquisition part 320 on the display 120 of the display apparatus 40 or on the display screen of the large screen display apparatus 50. Moreover, the display controller 330 forms and displays an image of the virtual three-dimensional space on the display 120 or on the display screen of the large screen display apparatus 50.

### (4-1. Arrangement of Subject Images in Virtual Three-Dimensional Space)

In the description below, it is supposed that the virtual three-dimensional space is displayed on the display screen of the large screen display apparatus 50 for convenience. Moreover, it is also supposed that subject images arranged in the virtual three-dimensional space are the subject images captured automatically by the party photographing function.

The virtual three-dimensional space is a virtual space which has a time axis corresponding to image capturing times in a radius direction of a circle with its center at the reference point in the space (for example, a viewpoint of the user) and has an orientation axis corresponding to image capturing positions in a circumferential direction of the circle. The display controller 330 draws the subject images at drawing positions based on the first capturing time information and first capturing position information acquired by the first acquisition part 310 in the virtual three-dimensional space to be formed as an image.

How the subject images are drawn in the virtual three-dimensional space is described specifically below.

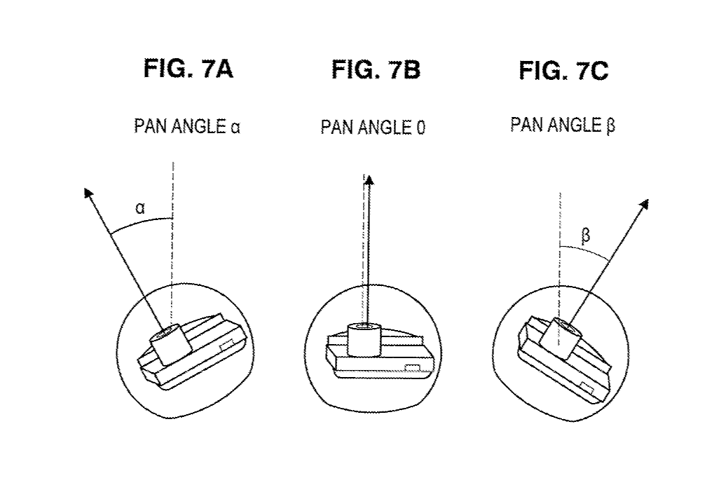

FIGS. 7A to 7C are diagrams illustrating relation between rotation angles of the rotational camera platform 30 and subject images captured by the image capturing apparatus 20. As mentioned above, the image capturing apparatus 20 is situated on the rotational camera platform 30, and captures images of the subject automatically by the party photographing function, rotating interlockingly with the rotation of the rotational camera platform 30. In FIGS. 7A to 7C, it is supposed that a subject image I1 is captured in the case where the rotation angle of the rotational camera platform 30 (pan angle) is an angle α counterclockwise from the north as the reference direction, that a subject image I2 is captured in the case where the rotation angle is 0 degrees, and that a subject image I3 is captured in the case where the rotation angle is an angle β clockwise.

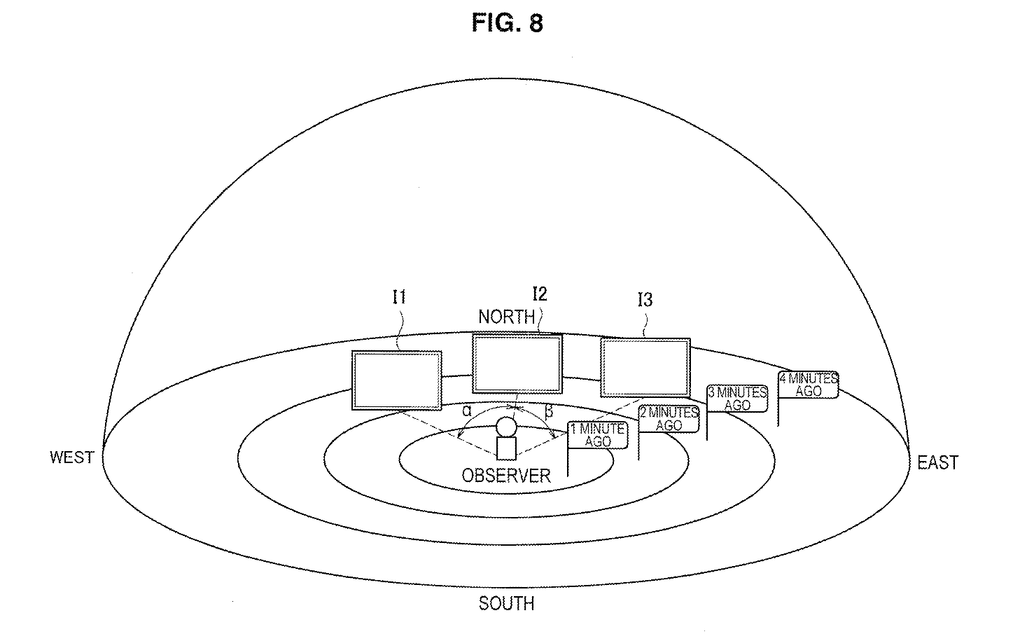

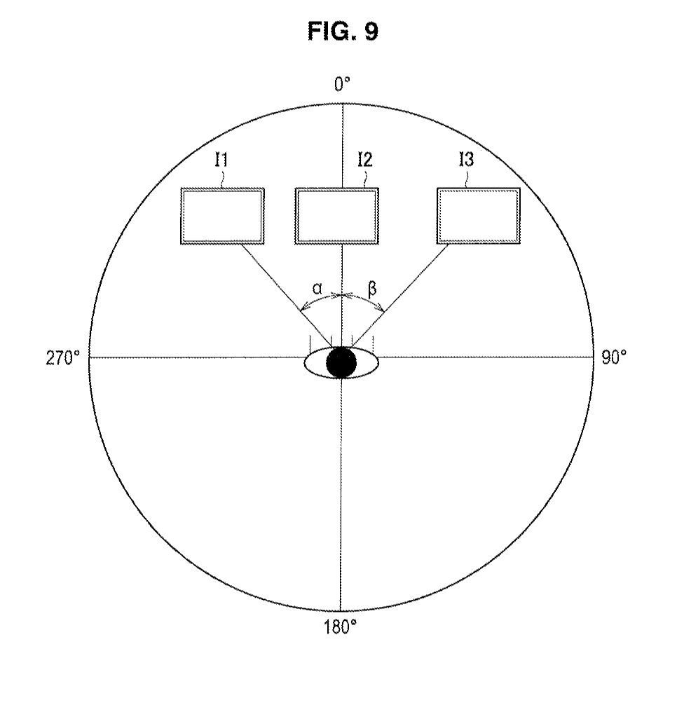

FIG. 8 is a diagram conceptually illustrating the virtual three-dimensional space in which the subject images captured with the rotation angles illustrated in FIGS. 7A to 7C are arranged. FIG. 9 is a top view illustrating the virtual three-dimensional space illustrated in FIG. 8. As illustrated in FIG. 8, the virtual three-dimensional space is a hemispherical space in which concentric circles are drawn with their center as the observer (viewpoint of the user of the image capturing apparatus 20), in which the radius direction of the concentric circles and the circumferential direction of the concentric circles correspond to the depth and the orientation, respectively, and which has the spread of 360 degrees.

The display controller 330 arranges the automatically captured plural subject images at the positions which reflect the image capturing times and image capturing positions in the virtual three-dimensional space. As illustrated in FIG. 8 and FIG. 9, the subject images I1 to I3 are arranged at the positions corresponding to the rotation angles of the rotational camera platform 30 illustrated in FIGS. 7A to 7C. In addition, in FIG. 9, the direction of the angle 0 degrees indicates the north, and the direction of the angle 90 degrees indicates the east. Moreover, the image of the eye located at the center of the circle indicates the viewpoint.

In the above description, the image capturing positions of the subject images are set corresponding to the rotation angles of the rotational camera platform 30. Incidentally, the image capturing apparatus 20 includes the electronic compass 170 as mentioned above, and therefore, the image capturing positions of the subject images may be set corresponding to the absolute orientations acquired by the electronic compass 170 and the rotation angles of the rotational camera platform 30.

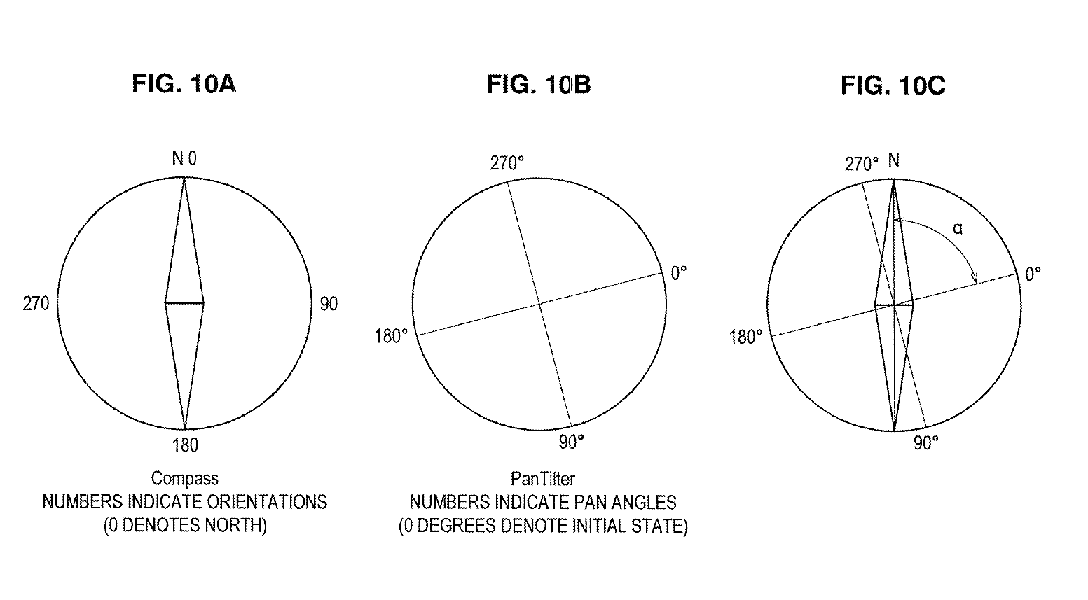

FIGS. 10A to 10C are diagrams illustrating relation between the orientations of the electronic compass 170 and the rotation angles of the rotational camera platform 30. When acquiring the subject images captured automatically, the first acquisition part 310 also acquires information on the rotation angles of the rotational camera platform 30 in capturing the images (angle information of 0 degrees to 359 degrees illustrated in FIG. 10B) associatively. Moreover, when acquiring the subject images, the first acquisition part 310 also acquires information on the absolute orientations measured by the electronic compass 170 in capturing the images (orientations illustrated in FIG. 10A) associatively.

In order to utilize these two kinds of information, the display control apparatus 300 determines an offset angle indicating a difference between the initial angle of the rotational camera platform 30 and the absolute orientation of the electronic compass 170 (offset angle α illustrated in FIG. 10C) at the beginning of capturing the images. Then, since the electronic compass 170 fluctuates, the display control apparatus 300 employs the angle obtained by adding the offset angle α and the rotation angle of the rotational camera platform 30 as an image capturing orientation of the image capturing apparatus 20. Thereby, the image capturing orientation can be determined more in high precision.

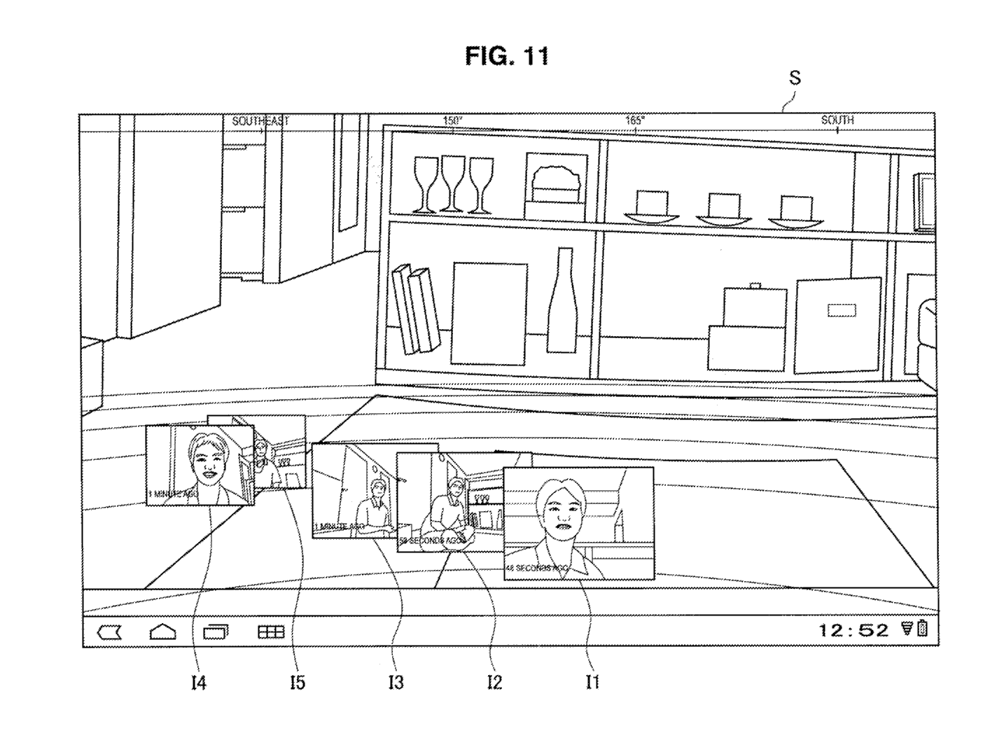

FIG. 11 is a diagram illustrating a display example of the virtual three-dimensional space in which the subject images are arranged by the display 120 or the large screen display apparatus 50. As illustrated in FIG. 11, the display controller 330 draws and displays the virtual three-dimensional space such that it is a scene seen from the viewpoint of the user. In FIG. 11, the horizontal axis, vertical axis and depth axis in the virtual three-dimensional space correspond to the orientation, altitude and time, respectively. Namely, the horizontal axis indicates the orientation of the place where the subject image has been captured, seen from the current position of the image capturing apparatus 20. The depth axis indicates the time when the subject image has been captured, seen from the current time. The vertical axis indicates the altitude of the place from the surface of the earth where the subject image has been captured.

In addition, when the altitude information is not recorded along with the subject image, the altitude is set to 0 and the subject image is arranged along the surface of the earth (bottom of the virtual three-dimensional space). Moreover, arrangement spaces of the subject images in the depth direction may be fixed spaces such as one hour interval and one day interval, for example, or variable spaces for which the spaces become larger exponentially as their distances from the viewpoint become larger such as one hour, one day, one year, ten years and the like, for example.

In FIG. 11, five subject images I1 to I5 which are different from one another in image capturing time and which are captured from different orientations are arranged in the virtual three-dimensional space and displayed as a two-dimensional image. Moreover, the virtual three-dimensional space illustrated in FIG. 11 has depth perception in the depth direction, and the sizes of the subject images are different according to the distances of the subject images from the current position. Namely, the subject image I1 which is nearest to the current position is the largest and the subject image I5 which is most separated from the current position is the smallest. In addition, the virtual three-dimensional space may not have the depth perception in the depth direction, or the sizes of the subject images I1 to I5 may be the same size. By displaying in this way, the user can grasp relation among the image capturing positions and image capturing times of the plural subject images easily.

### (4-2. Display of Subject Images and Panoramic Image in Virtual Three-Dimensional Space)

Returning to FIG. 6, the description continues. When drawing the subject images at the drawing positions in the virtual three-dimensional space, the display controller 330 also draws the panoramic image acquired by the second acquisition part 320 along with them such that the image capturing environment in capturing the images of the subject automatically can be grasped easily.

Specifically, the display controller 330 draws the panoramic image in the background part of the virtual three-dimensional space to be formed and displayed as an image. Moreover, the display controller 330 draws the panoramic image based on the second capturing position information acquired by the second acquisition part 320 such that the image capturing orientations of the subject images and panoramic image synchronize.

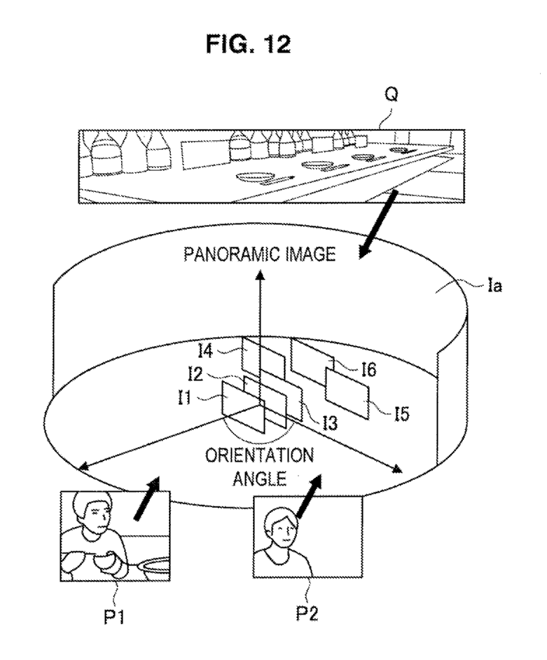

Herein, the display of the subject images and panoramic image in the virtual three-dimensional space is described specifically, referring to FIG. 12. FIG. 12 is a diagram for explaining drawing positions of the subject images and panoramic image in the virtual three-dimensional space.

As illustrated in FIG. 12, the display controller 330 also draws the panoramic image Q while arranging and drawing the subject images P1 and P2 in the virtual three-dimensional space. Herein, the panoramic image is arranged on the surface extending upward from the outer circumference of virtual three-dimensional space. At this stage, the display controller 330 draws the panoramic image and subject images such that the image capturing orientations of the panoramic image and subject images synchronize in the virtual three-dimensional space.

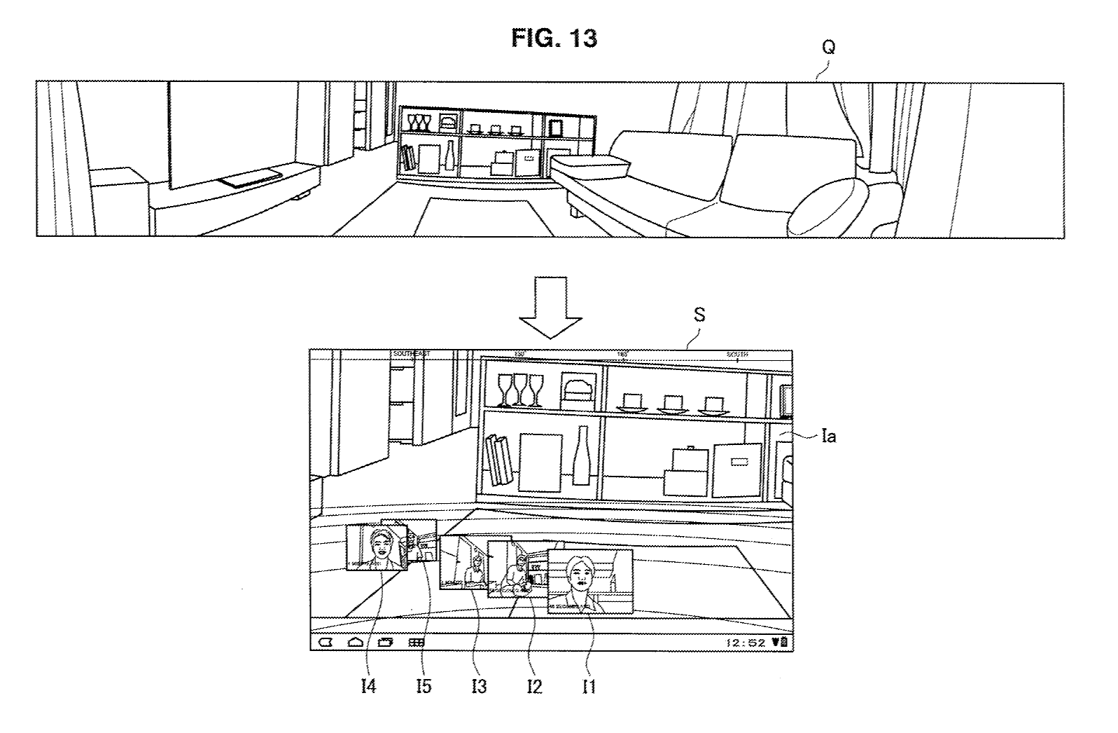

FIG. 13 is a diagram illustrating a display example of the subject images and panoramic image by the display 120 or the large screen display apparatus 50. As illustrated in FIG. 13, the subject images I1 to I5 are drawn on the bottom of the virtual three-dimensional space of the lower part of the display screen S, and the panoramic image Ia is drawn in the background part of the virtual three-dimensional space of the upper part of the display screen S. Since the panoramic image and the subject images are drawn separately, the user is easy to recognize the drawn panoramic image. Moreover, as illustrated in FIG. 13, the panoramic image Ia drawn on the display screen S is a part of the panoramic image Q which corresponds to the size of the display screen and is acquired by the second acquisition part 320.

Thus, in addition to the subject images, the panoramic image is arranged and displayed in the background part of the virtual three-dimensional space, and thereby, image capturing environment in which the images of the subject are captured automatically becomes easy to be perceived. Especially, since subject images to be captured are captured focusing on the face of the subject, their areas of the face of the subject occupying in the subject images are large. For this reason, when only the subject images are displayed portions other than the subject (for example, the captured background) can be hard to be grasped, whereas the image capturing environment in capturing the images of the subject can be grasped easily by displaying the panoramic image in the background part.

### (4-3. Outline of Drawing Subject Images in Virtual Three-Dimensional Space)

Returning to FIG. 6, the description continues. The display controller 330 rotates and displays the virtual three-dimensional space to the orientation corresponding to the image capturing position of the subject image, and draws the subject image at the drawing position of the virtual three-dimensional space thus rotated and displayed.

Specifically, the display controller 330 enlarges and displays the subject image for a predetermined time, after that, rotates and displays the virtual three-dimensional space in the state that the subject image is set to the non-display, and after the rotation and display of the virtual three-dimensional space, re-displays and draws the subject image at the drawing position. Moreover, the display controller 330 makes the subject image bound in the virtual three-dimensional space thus rotated and displayed, and after that, draws it at the drawing position.

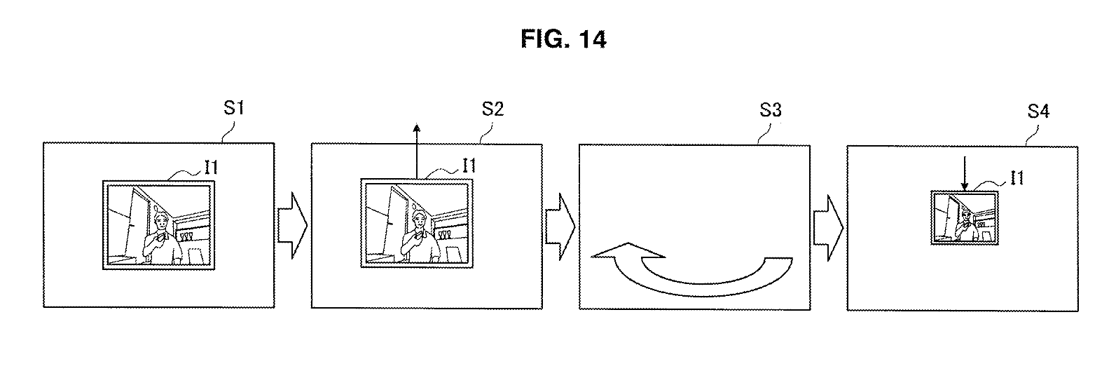

Herein, referring to FIG. 14, the flow is described in which the display controller 330 draws the subject image acquired from the first acquisition part 310 in the virtual three-dimensional space. FIG. 14 is a schematic diagram for explaining the flow in which the subject image acquired from the first acquisition part 310 is drawn in the virtual three-dimensional space.

After input of the subject image from the first acquisition part 310, as illustrated in a display screen S1, the display controller 330 display one subject image I1 in large size for a predetermined time. By the subject image I1 being displayed in such large size, it is easy to be perceived as the image captured automatically.

After a predetermined time elapses, as illustrated in a display screen S2, the display controller 330 slides the subject image to the outside of the screen. Thereby, the subject image I1 disappears from the screen. Herein, the subject image I1 is slid out of the screen upward.

After the sliding of the subject image I1 outside, as illustrated in a display screen S3, toward the image capturing orientation of the subject image I1, the display controller 330 rotates and displays the virtual three-dimensional space (that is, scrolls the display screen). Then, after the rotation and display of the virtual three-dimensional space, as illustrated in a display screen S4, the display controller 330 drops and displays the subject image I1 into the virtual three-dimensional space (slides it downward).

Herein, since the virtual three-dimensional space rotates, the background part of the subject image I1 in the display screen S4 is different from the image of the background part of the subject image I1 in the display screens S1 and S2. Thus, by rotating and displaying the virtual three-dimensional space, it can be perceptible that the subject image is captured by the image capturing apparatus 20 situated and rotating on the rotational camera platform 30.

Furthermore, the display controller 330 stage-manages the subject image I1 by making it bound over the drawing position on the bottom of the virtual three-dimensional space. By stage-managing in such a way, the image capturing position of the subject image I1 can be easy to be grasped visually.

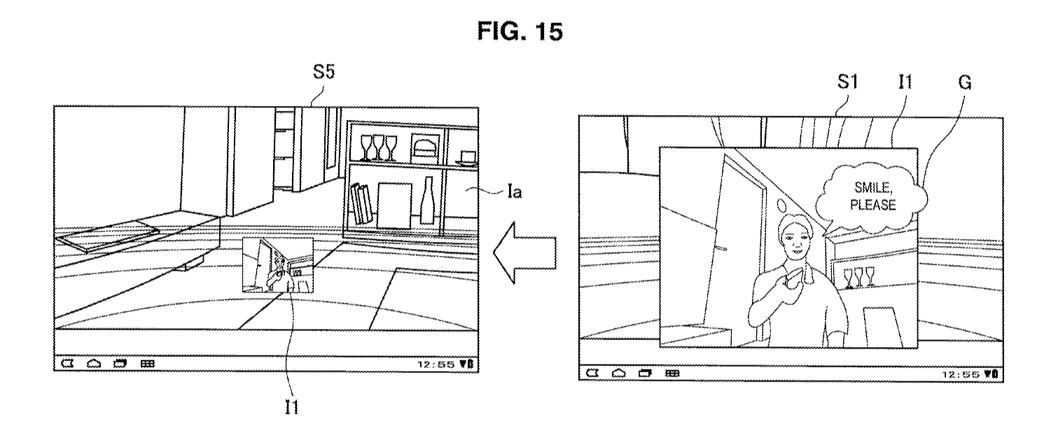

FIG. 15 is a diagram illustrating a display example of the subject image by the display 120 or the large screen display apparatus 50. As illustrated in a display screen S1 in FIG. 15, the subject image I1 is displayed in large size. At this stage, the display controller 330 may display a balloon G in which a comment is described. The comment is an objective comment of a third party to the subject of the subject image I1, for example. The comment may be a comment of the subject of the subject image I1. In a display screen S5 of FIG. 15, the state where the subject image I1 is drawn at the drawing position after the rotation and display of the virtual three-dimensional space is indicated.

### (4-4. Switching Display of Panoramic Images in Response to Viewpoint Movement)

Returning to FIG. 6, the description continues. As to the virtual three-dimensional space displayed on the display screen, the operation accepting part 340 accepts a moving operation of the viewpoint of the user in the virtual three-dimensional space. For example, by detecting a touch operation in the input part 250 (touch panel) of the display apparatus 40, the operation accepting part 340 accepts the moving operation of the viewpoint on the time axis of the virtual three-dimensional space in the virtual three-dimensional space.

According to the moving operation of the viewpoint which the operation accepting part 340 accepts, the display controller 330 switches the panoramic images and draws it. For example, the display controller 330 switchingly draws the panoramic image captured at the image capturing time corresponding to the position of the viewpoint having moved on the time axis. Thereby, the image capturing scenery according to the image capturing time can be grasped. In addition, the panoramic images which are switchingly drawn may be captured previously at a predetermined interval, or may be captured every time when the scene is switched.

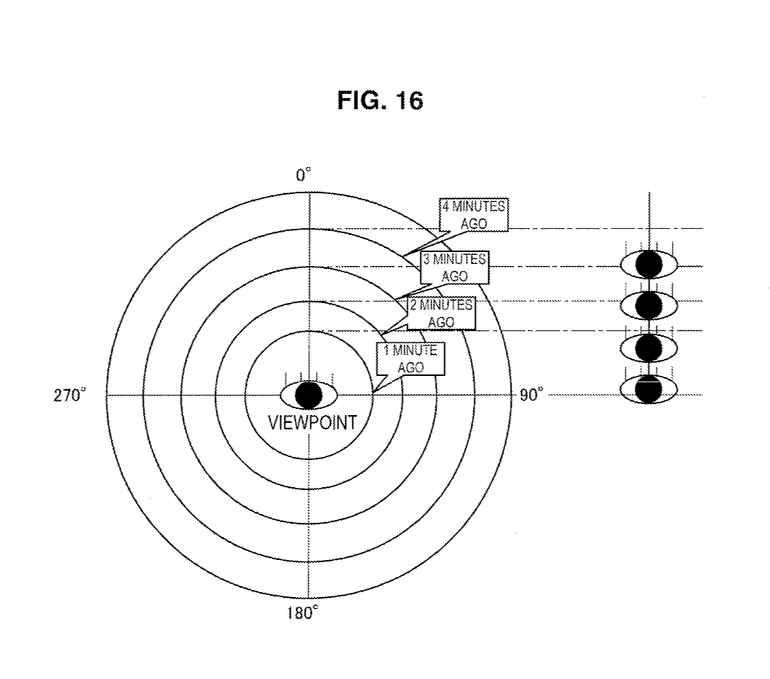

Herein, referring to FIG. 16, the switching display of the panoramic images in response to the viewpoint movement in the virtual three-dimensional space is described. FIG. 16 is a diagram for explaining movement of a viewpoint in the virtual three-dimensional space.

In FIG. 16, when the user moves the viewpoint upward, the display controller 330 switches the display from the panoramic image displayed at the present time to the panoramic image captured a predetermined time ago in the radius direction as the time axis of the virtual three-dimensional space. Thus, by switching the panoramic images according to the viewpoint movement in the virtual three-dimensional space, the time-course change of the panoramic images thus drawn can be perceived.

In addition, in the above, the virtual three-dimensional space as a virtual space is exemplarily described which has the orientation axis in the circumferential direction of the circle and the time axis in the radius direction of the circle, whereas it is not limited to this. For example, the virtual space only has to have the orientation axis corresponding to the image capturing positions of the subject images in central circumferential direction of the circle with its center at the reference point in the space, and the radius direction may correspond to an axis other than the time axis (for example, the axis of the distance).

### 5. Operation of Image Display System

### (Display Processing of Subject Images and Panoramic Image in Virtual Three-Dimensional Space)

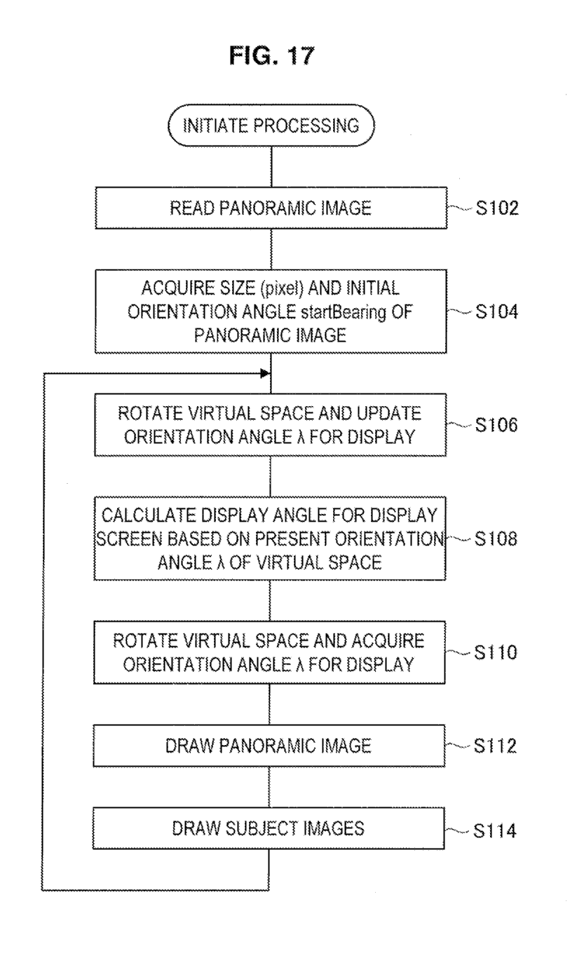

Referring to FIG. 17 to FIGS. 19A and 19B, display processing of the subject images and panoramic image in the virtual three-dimensional space is described.

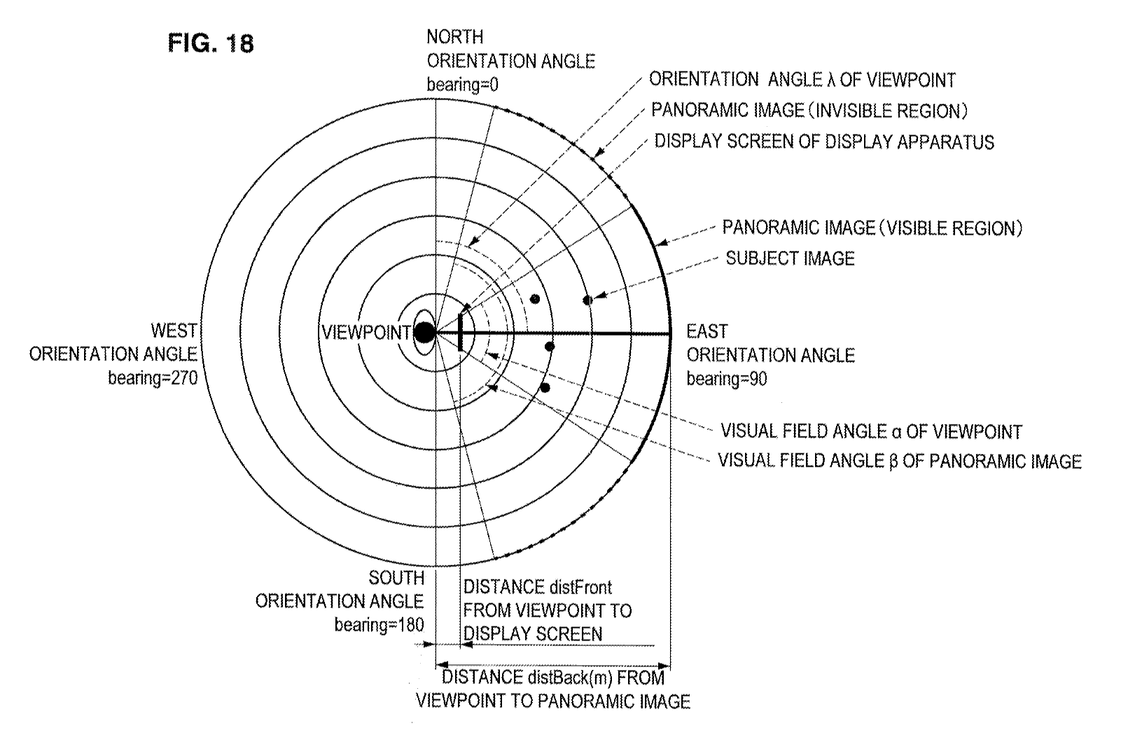

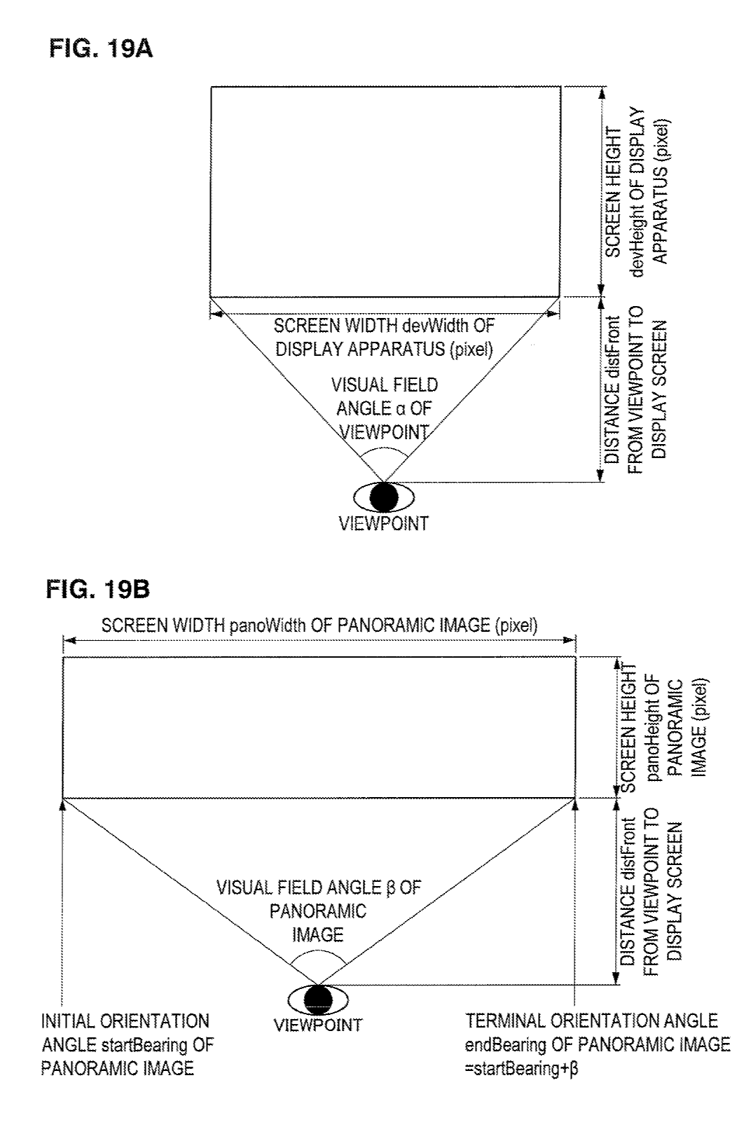

FIG. 17 is a flowchart illustrating the display processing of the subject images and panoramic image in the virtual three-dimensional space. FIG. 18 is a diagram for explaining an orientation angle and the like of the viewpoint in the virtual three-dimensional space. FIGS. 19A and 19B are diagrams illustrating relation between the panoramic image and display screen. The flowchart illustrated in FIG. 17 starts with the step where the subject images and panoramic image have been captured by the image capturing apparatus 20.

The processing is realized by the CPU executing a program stored in the ROM. In addition, the executed program may be stored in a recording medium such as a CD (Compact Disk), a DVD (Digital Versatile Disk) and a memory card, and may be downloaded from a server or the like via the Internet.

First, the display controller 330 reads the panoramic image which the second acquisition part 320 has acquired from the image capturing apparatus 20 (Step S102). Then, the display controller 330 acquires a size (Pixel) and an initial orientation angle startBearing of the panoramic image illustrated in FIG. 19B (Step S104).

Next, the display controller 330 rotates the virtual three-dimensional space to be drawn, and updates an orientation angle λ of a viewpoint for display (FIG. 18) (Step S106). Then, the display controller 330 calculates a display angle to the display screen based on the present orientation angle λ of the virtual space (Step S108).

Next, the display controller 330 rotates the virtual three-dimensional space, and acquires an orientation angle λ of a viewpoint for display (Step S110). In FIG. 18, the viewpoint faces toward the east and the orientation angle λ is 90 degrees.

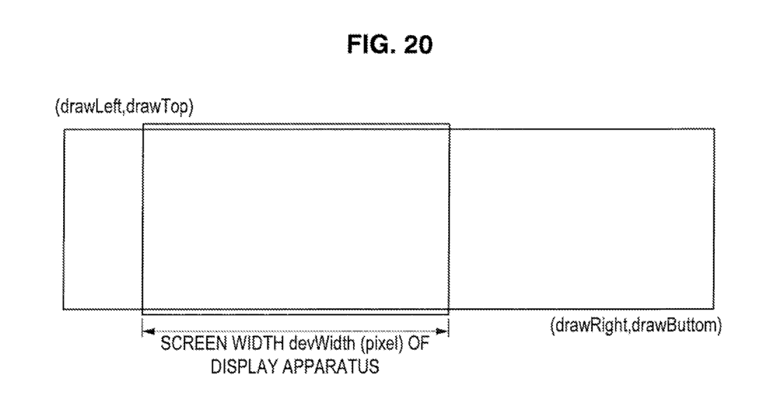

Next, the display controller 330 draws the panoramic image in the background part of the virtual three-dimensional space (Step S112). Herein, the calculation method in drawing the panoramic image is described referring to FIG. 20. FIG. 20 is a diagram illustrating relation between the panoramic image and the display screen of the display apparatus.

First, a pixel number (pixPerAngleEye) per one degree of the visual field of the viewpoint illustrated in FIG. 19A is calculated by the following formula.

pixPerAngleEye=devWidth/α

Moreover, a pixel number (pixPerAnglePano) per one degree of the visual field of the panoramic image illustrated in FIG. 19B is calculated by the following formula.

pixPerAnglePano=panoWidth/β

Then, a conversion factor (convCoefficients) of the panoramic image to the coordinate system of the display screen is calculated by the following formula.

convCoefficients=pixPerAngleEye/pixPerAnglePano

And when arranging the panoramic image on the display screen, a coordinate drawLeft at the left end of the panoramic image illustrated in FIG. 20 is calculated by the following formula based on the initial orientation angle startBearing of the panoramic image and the orientation angle λ of the viewpoint, where the coordinate of the center of the display screen is devWidth/2.

drawLeft=(devWidth/2)+(startBearing−λ)*pixPerAngleEye

Similarly, a coordinate drawRight at the right end of the panoramic image illustrated in FIG. 20 is calculated by the following formula.

drawRight=drawLeft+panoWidth*convCoefficients

Moreover, coordinates drawTop and drawButtom at the upper and lower ends of the panoramic image are calculated by the following formulas, respectively.

drawTop=0

drawButtom=panoHeight*convCoeffients

The panoramic image is drawn based on the above-mentioned calculation results.

Returning to FIG. 17, the description continues. The display controller 330 draws the subject images at predetermined drawing positions in the virtual three-dimensional space (Step S114). Thereby, as illustrated in FIG. 13, for example, both the panoramic image and subject images are displayed in the virtual three-dimensional space, and the environment where the subject images have been captured can be grasped easily.

### (Drawing Processing of Subject Images in Virtual Three-Dimensional Space)

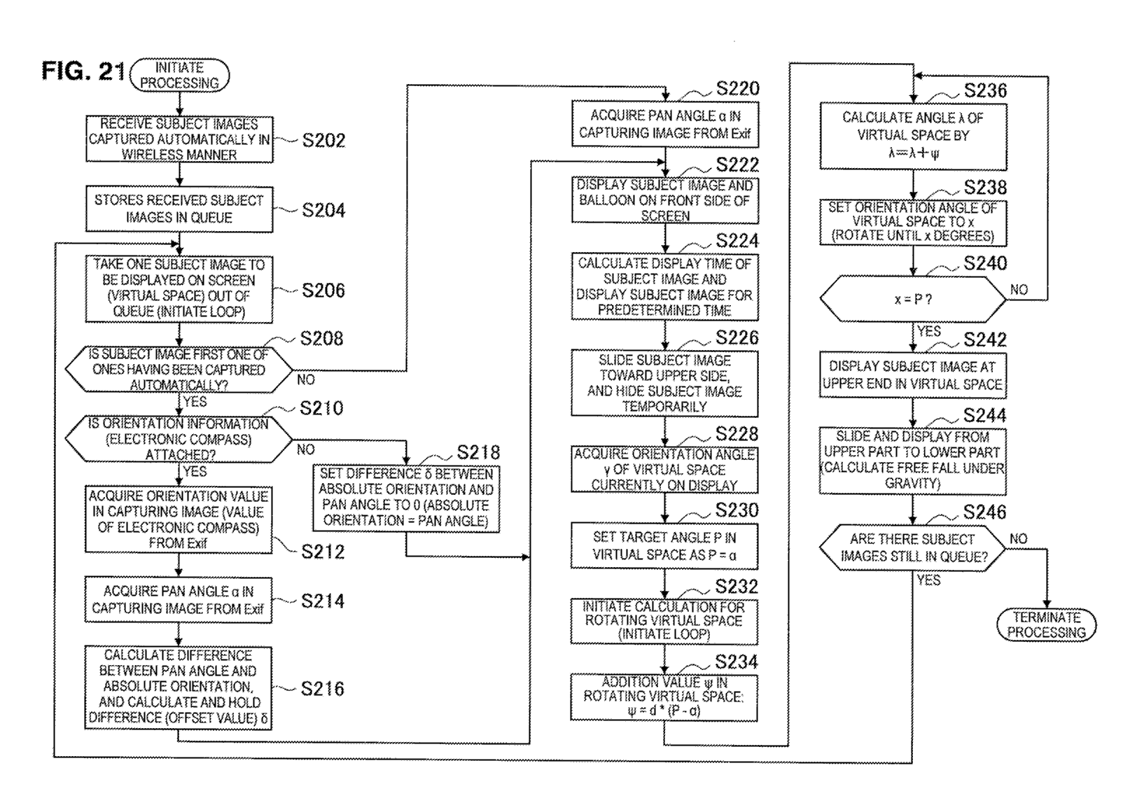

Referring to FIG. 21, drawing processing of arranging the subject images captured automatically in the virtual three-dimensional space is described. FIG. 21 is a flowchart illustrating the drawing processing of the subject images captured automatically in the virtual three-dimensional space. The flowchart starts with the step where the subject images have been captured automatically by the image capturing apparatus 20.

The first acquisition part 310 receives the subject images having been captured automatically (Step S202), and stores the subject images thus received in the queue of the storage (Step S204). Herein, the first acquisition part 310 receives the plural subject images.

Next, the display controller 330 takes one subject image to be displayed on the screen (virtual three-dimensional space) out of the queue (Step S206). Then, the display controller 330 determines whether or not the subject image thus taken is the first one of the plural subject images having been captured automatically (Step S208).

When it is determined that the subject image is the first one in Step S208 (Yes), the display controller 330 further determines whether or not the orientation information is attached to the subject image (Step S210). Then, when the orientation information is attached to the subject image in Step S210 (Yes), the display controller 330 acquires the orientation value in capturing the image (value of the electronic compass) from an Exif (image capturing information such as the orientation) (Step S212).

Moreover, the display controller 330 acquires a pan angle α of the rotational camera platform 30 in capturing the image of the subject from the Exif (Step S214). Then, the display controller 330 calculates a difference between the pan angle of the rotational camera platform 30 and the absolute orientation, and calculates and holds the difference (offset value) δ (Step S216).

When the orientation information is not attached to the subject image in Step S210 (No), the display controller 330 sets the difference δ between the absolute orientation and the pan angle of the rotational camera platform 30 to 0 (Step S218). Namely, the absolute orientation and the pan angle of the rotational camera platform 30 have the same quantity.

Next, the display controller 330 displays the subject image and balloon on the front side of the screen (Step S222). Then, the display controller 330 calculates a display time of the subject image, and displays the subject image for the predetermined time (Step S224). After that, the display controller 330 slides the subject image toward the upper side, and hides the subject image temporarily (Step S226).

Next, the display controller 330 acquires the orientation angle γ of the virtual three-dimensional space currently on display (Step S228). Then, the display controller 330 sets a target angle P of the virtual three-dimensional space to the pan angle α (Step S230).

Next, the display controller 330 initiates calculation for rotating the virtual three-dimensional space (Step S232). The display controller 330 calculates an addition value φ in rotating the virtual three-dimensional space by the following formula (Step S234).

φ=d*(P−α)

Next, the display controller 330 calculates an angle λ of the virtual three-dimensional space by the following formula (Step S236).

λ=λ+φ

Next, the display controller 330 sets the orientation angle of the virtual three-dimensional space to x (Step S238). Namely, the display controller 330 rotates the virtual three-dimensional space until x degrees. Then, the display controller 330 determines whether or not the orientation angle x becomes same as the target angle P (Step S240).

When the orientation angle x does not reach the target angle P in Step S240 (No), the display controller 330 repeats Steps S238 and S240 mentioned above. When the orientation angle x reaches the target angle P in Step S240 (Yes), the display controller 330 displays the subject image at the upper end of the virtual three-dimensional space (Step S242). Then, the display controller 330 slides and displays the subject image from the upper part to the lower part (Step S244).

Next, the display controller 330 determines whether or not the subject images are still stored in the queue (Step S246). When the subject images are still stored in the queue in Step S246 (Yes), the display controller 330 repeats the processes mentioned above. However, since the subject image taken out of the queue is the second one or the later one in this case, the display controller 330 acquires the pan angle α in capturing the image from the Exif (Step S220), instead of performing Steps S210 to S218. When there is no subject image in the queue in Step S246 (No), the processing terminates.

### 6. Conclusion

As mentioned above, the information processing apparatus draws a panoramic image (wide range image) as well when drawing a subject image at a drawing position of a virtual three-dimensional space (virtual space). Herein, the panoramic image is an image which is captured with a visual field in a wider range than that for a visual field in capturing an image of the subject. Therefore, the environmental or the like where the image of the subject has been captured can be grasped easily due to the panoramic image drawn along with the subject image. Especially, in a party photographing function, the face of the subject tends to be captured so as to occupying large in size in the subject image to be captured automatically. For this reason, it can be hard to grasp the image capturing environment by arranging only the subject image in the virtual three-dimensional space, whereas such a problem is solvable by the panoramic image drawn along with it.

As above, preferred embodiments of the present disclosure will be described in detail with reference to the appended drawings, whereas the technical scope of the present disclosure is not limited to such examples. It should be understood by those skilled in the art that various modifications, combinations, sub-combinations and alterations may occur depending on design requirements and other factors insofar as they are within the scope of the appended claims or the equivalents thereof and that they naturally belong to the technical scope of the present disclosure.

Moreover, the steps illustrated in the flowcharts of the above-mentioned embodiments includes, needless to say, processes performed in a time-series manner in the described order, and also processes performed in parallel or individually unnecessarily in a time-series manner. Moreover, it is not expected to be overemphasized that even steps processed in a time-series manner can be changed in terms of the processing order suitably in some cases.

The processes by the display control apparatus described in the present specification may be realized using any of software, hardware and a combination of software and hardware. Programs constituting the software are beforehand stored in a recording medium provided in the inside or outside of each apparatus, for example. Then, each program is read into a RAM (Random Access Memory) in execution and is executed by a processor such as a CPU, for example.

Note that the present technology may also be configured as below.

(1) An information processing apparatus comprising:

a first acquisition part acquiring a subject image obtained by capturing an image of a subject and first capturing position information indicating an image capturing position of the subject image;

a second acquisition part acquiring a wide range image captured with a visual field in a wider range than that for a visual field in capturing an image of the subject and second capturing position information indicating an image capturing position of the wide range image; and

a display controller forming and displaying an image of a virtual space having an orientation axis corresponding to the image capturing position in a circumferential direction of a circle with its center at a reference point in the virtual space, wherein the display controller

draws the wide range image as well based on the second capturing position information, when drawing the subject image at a drawing position based on the first capturing position information in the virtual space.

(2) The information processing apparatus according to (1), wherein

the subject image is an image obtained by capturing an image of a face of the subject, and

the wide range image is a panoramic image.

(3) The information processing apparatus according to (1) or (2), wherein

the display controller draws the wide range image in a background part of the virtual space which is formed and displayed as an image based on the second capturing position information.

(4) The information processing apparatus according to any one of (1) to (3), wherein

the subject image and the wide range image are images captured by an image capturing apparatus which is situated on a freely rotatable rotational camera platform and rotates interlockingly with rotation of the rotational camera platform.

(5) The information processing apparatus according to any one of (1) to (4), wherein

the display controller

rotates and displays the virtual space to an orientation corresponding to the image capturing position of the subject image, and

draws the subject image at the drawing position of the rotated and displayed virtual space.

(6) The information processing apparatus according to (5), wherein

the display controller draws the subject image, after making it bound in the rotated and displayed virtual space, at the drawing position.

(7) The information processing apparatus according to (5) or (6), wherein

the display controller

enlarges and displays the subject image for a predetermined time, after that, rotates and displays the virtual space in the state that the subject image is set to non-display, and

after the rotation and display of the virtual space, re-displays and draws the subject image at the drawing position.

(8) The information processing apparatus according to any one of (1) to (7), wherein

the first acquisition part further acquires first capturing time information indicating an image capturing time of the subject image, and

the display controller sets a radius direction of a circle with its center at a reference point in the virtual space as a time axis and draws the subject image at a drawing position based on the first capturing time information and the first capturing position information in the virtual space.

(9) The information processing apparatus according to (8), further comprising

an operation accepting part accepting, in the displayed virtual space, a moving operation of a viewpoint of a user in the virtual space, wherein

the second acquisition part acquires a plurality of wide range images, and

the display controller switchingly draws the wide range image according to the moving operation of the viewpoint which the operation accepting part accepts.

(10) The information processing apparatus according to (9), wherein

the plurality of wide range images are different in image capturing time,

the operation accepting part accepts, in the displayed virtual space, a moving operation of the viewpoint of the user on the time axis of the virtual space, and

the display controller switchingly draws the wide range image captured at the image capturing time corresponding to a position of the view point having been moved on the time axis.

(11) The information processing apparatus according to (4), wherein

the image capturing position of the first capturing position information is set based on a rotation angle of the image capturing apparatus in capturing and an absolute orientation of the image capturing apparatus.

(12) An information processing method comprising:

acquiring a subject image obtained by capturing an image of a subject and first capturing position information indicating an image capturing position of the subject image;

acquiring a wide range image captured with a visual field in a wider range than that for a visual field in capturing an image of the subject and second capturing position information indicating an image capturing position of the wide range image;

forming and displaying an image of a virtual space having an orientation axis corresponding to the image capturing position in a circumferential direction of a circle with its center at a reference point in the virtual space; and

drawing the wide range image as well based on the second capturing position information when drawing the subject image at a drawing position based on the first capturing position information in the virtual space.

(13) A program causing a computer to execute:

acquiring a subject image obtained by capturing an image of a subject and first capturing position information indicating an image capturing position of the subject image;

acquiring a wide range image captured with a visual field in a wider range than that for a visual field in capturing an image of the subject and second capturing position information indicating an image capturing position of the wide range image;

forming and displaying an image of a virtual space having an orientation axis corresponding to the image capturing position in a circumferential direction of a circle with its center at a reference point in the virtual space; and

drawing the wide range image as well based on the second capturing position information when drawing the subject image at a drawing position based on the first capturing position information in the virtual space.

What is claimed is:

1. An information processing apparatus comprising:
a first acquisition part acquiring a subject image obtained by capturing an image of a subject and first capturing position information indicating an image capturing position of the subject image;
a second acquisition part acquiring a wide range image captured with a visual field in a wider range than that for a visual field in capturing an image of the subject and second capturing position information indicating an image capturing position of the wide range image; and
a display controller forming and displaying an image of a virtual space having an orientation axis corresponding to the image capturing position in a circumferential direction of a circle with its center at a reference point in the virtual space, wherein
the display controller
draws the wide range image as well based on the second capturing position information, when drawing the subject image at a drawing position based on the first capturing position information in the virtual space.

2. The information processing apparatus according to claim 1, wherein
the subject image is an image obtained by capturing an image of a face of the subject, and
the wide range image is a panoramic image.

3. The information processing apparatus according to claim 1, wherein
the display controller draws the wide range image in a background part of the virtual space which is formed and displayed as an image based on the second capturing position information.

4. The information processing apparatus according to claim 1, wherein
the subject image and the wide range image are images captured by an image capturing apparatus which is situated on a freely rotatable rotational camera platform and rotates interlockingly with rotation of the rotational camera platform.

5. The information processing apparatus according to claim 1, wherein
the display controller
rotates and displays the virtual space to an orientation corresponding to the image capturing position of the subject image, and
draws the subject image at the drawing position of the rotated and displayed virtual space.

6. The information processing apparatus according to claim 5, wherein
the display controller draws the subject image, after making it bound in the rotated and displayed virtual space, at the drawing position.

7. The information processing apparatus according to claim 5, wherein
the display controller
enlarges and displays the subject image for a predetermined time, after that, rotates and displays the virtual space in the state that the subject image is set to non-display, and
after the rotation and display of the virtual space, re-displays and draws the subject image at the drawing position.

8. The information processing apparatus according to claim 1, wherein
the first acquisition part further acquires first capturing time information indicating an image capturing time of the subject image, and
the display controller sets a radius direction of a circle with its center at a reference point in the virtual space as a time axis and draws the subject image at a drawing position based on the first capturing time information and the first capturing position information in the virtual space.

9. The information processing apparatus according to claim 8, further comprising
an operation accepting part accepting, in the displayed virtual space, a moving operation of a viewpoint of a user in the virtual space, wherein
the second acquisition part acquires a plurality of wide range images, and
the display controller switchingly draws the wide range image according to the moving operation of the viewpoint which the operation accepting part accepts.

10. The information processing apparatus according to claim 9, wherein
the plurality of wide range images are different in image capturing time,
the operation accepting part accepts, in the displayed virtual space, a moving operation of the viewpoint of the user on the time axis of the virtual space, and
the display controller switchingly draws the wide range image captured at the image capturing time corresponding to a position of the view point having been moved on the time axis.

11. The information processing apparatus according to claim 4, wherein
the image capturing position of the first capturing position information is set based on a rotation angle of the image capturing apparatus in capturing and an absolute orientation of the image capturing apparatus.

12. An information processing method comprising:
acquiring a subject image obtained by capturing an image of a subject and first capturing position information indicating an image capturing position of the subject image;
acquiring a wide range image captured with a visual field in a wider range than that for a visual field in capturing an image of the subject and second capturing position information indicating an image capturing position of the wide range image;
forming and displaying an image of a virtual space having an orientation axis corresponding to the image capturing position in a circumferential direction of a circle with its center at a reference point in the virtual space; and
drawing the wide range image as well based on the second capturing position information when drawing the subject image at a drawing position based on the first capturing position information in the virtual space.

13. A program causing a computer to execute:
acquiring a subject image obtained by capturing an image of a subject and first capturing position information indicating an image capturing position of the subject image;
acquiring a wide range image captured with a visual field in a wider range than that for a visual field in capturing an image of the subject and second capturing position information indicating an image capturing position of the wide range image;
forming and displaying an image of a virtual space having an orientation axis corresponding to the image capturing position in a circumferential direction of a circle with its center at a reference point in the virtual space; and
drawing the wide range image as well based on the second capturing position information when drawing the subject image at a drawing position based on the first capturing position information in the virtual space.
